(19) United States
(12) Patent Application Publication
(10) Pub. No.: US 2002/0166890 A1
(43) Pub. Date: Nov. 14, 2002

(54) Universal power supply system

(75) Inventors: Min-Chih Hsuan, Hsinchu (TW); Paul Lee, Taipei Hsien (TW)

Correspondence Address: J.C. Patents, Inc, 4 Venture, Suite 250, Irvine, CA, 92618, US

(73) Assignee: United Microelectronics Corp.,, Hsinchu (TW)

(21) Appl. No.: 09/853,381

(22) Filed: May 11, 2001

(51) Int. Cl. G06F 17/00

(52) U.S. Cl. 235/375

(57) ABSTRACT

A universal power supply system has a device circuit, a universal power supply, and a standard interface unit coupled between the device circuit, and the universal power supply, whereby a required power is supplied to the electronic product. The device circuit includes a device ID code unit to provide an ID code, and a power input interface by which the required power can be inputted to the device circuit. The universal power supply includes a voltage supply unit, a device ID detecting unit that can detect the device ID code through the standard interface, and a voltage control unit to control the voltage supply unit for providing the required power type through the standard interface.

### BACKGROUND OF THE INVENTION

1. Field of Invention

The present invention relates to a power supply system. More particularly, the present invention relates to a universal power supply system, which can intelligently supply a specific voltage for various types of device circuits.

2. Description of Related Art

As semiconductor fabrication technology develops, dimensions of electronic devices have been greatly reduced. This allows many electronic devices to be small enough to be portable, such as the portable personal computer, cellular phone, camcorder, digital cameras, portable DVD, portable CD, cassette, MP3 player, and personal digital assistants (PDA). When these portable electronic devices are operated in an area having no public power source, they need batteries to supply the electric power. However, when electric power is supplied by a battery, it has limitations due its limited storage capacity. This can be very inconvenient for the user.

In order to continuously use the electronic devices, typically a user needs to pre-purchase specific batteries for backup power. Since the specifications of batteries for different electronic products are not always the same, it is necessary to have many different types of batteries. Also the user may need to buy many specific chargers with respect to the specific electronic products. The chargers can only be operated using the public standard power source. This can also be very inconvenient.

Therefore, even though a portable product has its advantages, its advantages can be limited by lack of usable operating time. This limitation is more obvious for products with higher power consumption, such as PC, PDA, and Cellular phones. When using batteries these products can have short usage time, and their batteries typically cannot be widely used. This factor causes a degradation of performance for the portable products. The difficulty of low battery usage times is an issue that manufacturers must work to solve..

### SUMMARY OF THE INVENTION

The invention provides a universal power supply system, which can supply power to various types of products through a universal power supply. The use of a backup battery can effectively simplified.

As embodied and broadly described herein, the invention provides a universal power supply system, which comprises a device circuit, a universal power supply, and a standard interface unit coupled between the device circuit and the universal power supply, whereby a required power is supplied to the electronic product. The device circuit includes a device ID code unit, and a power input interface by which the required power can be inputted to the device circuit. The universal power supply includes a voltage supply unit, a device ID detecting unit that can detect the device ID code through a standard interface, and a voltage control unit to control the voltage supply unit for providing the required power type through the standard interface.

In the foregoing, the voltage supply unit of the universal power supply includes a rechargeable battery, and a charger to charge the rechargeable battery.

In the foregoing, the voltage supply unit of the universal power supply includes a power transforming apparatus, which allows an external public power source to be transformed into the battery-type power.

In the foregoing, the standard interface unit includes a standard interface having several plug holes, and a multi-wire cable. The plug holes and the wires of the cable are coupled, respectively. Function of each of the plug holes is defined, according to the type of the device circuit. The multi-wire cable connects between the device circuit and the universal power supply.

The multi-wire cable includes a power line, a grounded line, an ID signal line, and a safety signal line, where the power line transmits the intended voltage, the ID signal line is used to transmit the device ID code, and the safety signal line is used to transmit a safety signal.

The invention also provides a method for providing voltage for a device circuit. The method includes pre-setting the device circuit with a device ID code, and then detecting the device's ID code to recognize the type of device circuit. According to the device ID code, a requested power type with respect to the device circuit is sent thereto.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram, schematically illustrating the principle for a universal power supply system, according to an embodiment of this invention; and

FIG. 2 is a block diagram, schematically illustrating a universal power supply system, according to one preferred embodiment of this invention.

### DESCRIPTION OF THE PREFERRED EMBODIMENTS

One feature of the inventionas introduced is a universal power supply (UPS), which can supply an intended power type through a standard interface, according to various different types of electronic products. In other words, one USP is suitable for supplying different voltages to different types of device circuits.

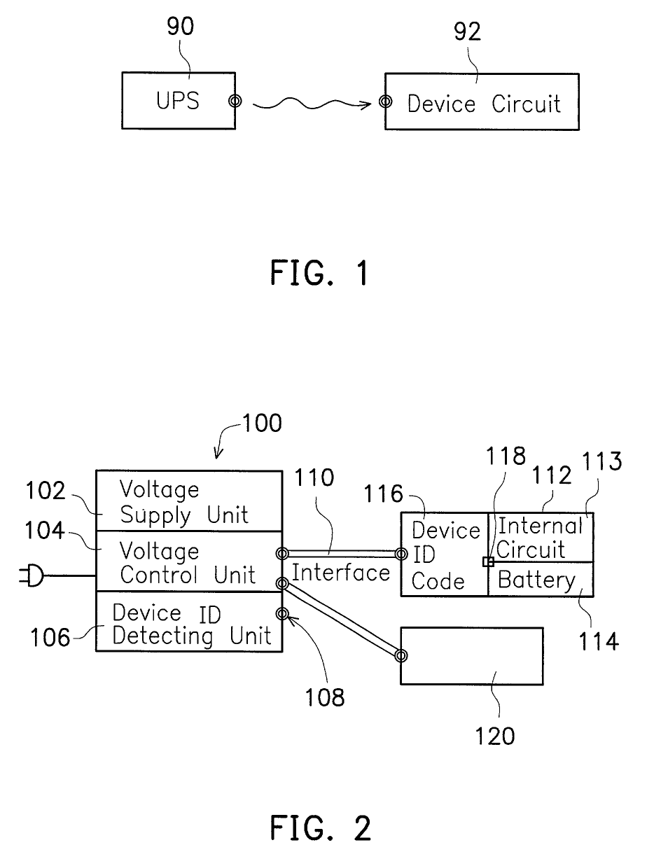

An embodiment is provided in the following for descriptions of the invention. FIG. 1 is a block diagram, schematically illustrating a principle for a universal power supply system, according to an embodiment of the invention. In FIG. 1, a UPS 90 can supply the intended power type to various types of device circuits 92. The device circuit 92 includes, for example, a personal computer, cellular phone, camcorder, digital camera, portable DVD, portable CD, cassette, MP3 player, personal digital assistance (PDA), or any portable electronic products.

As mentioned, the portable electronic products can include various types, and each type of electronic product may have a different power type. The battery used may also be different geometric structure, and therefore cannot be commonly used. This can be very inconvenient. The motivation of the invention, as shown in FIG. 1, introduces the UPS 90, which can supply the intended voltage, according to different electronic products needs. Even further, the UPS 90 can simultaneously supply intended voltage sources for two or more different products.

FIG. 2 is a block diagram, schematically illustrating a universal power supply system, according to one preferred embodiment of this invention. In FIG. 2, a UPS system includes a UPS unit 100, a standard interface 110, and at least one device circuit 112, 120. Using device circuit 112 as an example, it includes an internal circuit 113, and a battery 114 to supply the needed voltage for the internal circuit 113. In addition, the device circuit 112 also includes a device ID code unit 116 and a power input interface 118. The device ID code unit 116 stores a specific ID code for the device circuit 112, so that the type of the device circuit 112 can be recognized, and thereby the needed power type can be determined. Moreover, the power input interface 118, serves as a power input end to receive power from the battery 114 or from the UPS unit 100.

The UPS 100 includes a voltage supply unit 102, such as a re-chargeable battery with a charger, or a power transforming apparatus that can convert a public AC power source through a socket into a battery-type power source. The power transforming apparatus includes, for example, a regulator, a transformer, and so on. The UPS unit 100 further includes a voltage control unit 104 and a device ID detecting unit 106. The device ID detecting unit 106 can detect and thereby determine the device ID code of the device circuit 112. It even can simultaneously supply the voltages sources to at least two device circuits 112,120.

In order to provide various specific power types, the standard interface 110 between the UPS unit 100 and the device circuit 112 is used and coupled between them. The standard interface 110 can transfer the power source to an intended device without being affected by the type of the device circuit 112. The standard interface 110 can include, for example, a standard connector 108 to serve as an I/O end, and a multi-wire cable. The UPS unit 100 can obtain the device ID code of the device circuit 112 and supply the needed power type to the device circuit 112 through the standard connector 108, and the multi-wire cable.

In order to be suitable for the device type 112, the standard connector 108 needs a standardized size with several plug holes. Each plug hole is respectively connected to one wire of the multi-wire cable. Each of the plug holes is assigned with a function, according to the type of the device circuit 112. The function can be, for example, assigned by the voltage control unit 104. The plug holes include, for example, a power line hole, a grounded line hole, ID detecting line hole, and a safety line hole. The power line hole can provide the needed power. The ID detecting line hole can be used to transmit the ID code signal, the safety hole can be used to transmit a safety signal. The safety signal can include several monitoring signals. For example, a warning signal can be sent when the battery is overheating. The UPS unit should stop if necessary. The safety signal can also include a failure signal when the ID code is not successfully detected. Each wires of the multi-wire cable are connected to the plug holes, respectively.

Since each device type 112 may need a different power type, the number of plug holes being used and their function may be different each time. In this situation, some plug holes may be floating. Moreover, the plug hole may also include some backup holes.

In the invention, a standard interface is provided, so that the battery can supply power to device circuits with different specifications.

According to the principle, the invention also introduces a method to supply a power to a device circuit. The method can include pre-setting the device circuit 112 with a device ID code. Then, the device ID code is detected to recognize the type of the current device circuit 112. The voltage supply unit 102 supplies a power type-according to the device ID code, and sends it to the device circuit 112.

Moreover, a status signal of supplying power is also detected, to know whether the power is being properly supplied.

In conclusion, the invention has introduced a standard interface 110, associated with the voltage control unit 104 and the device ID detecting code 106 of the UPS unit 100, and the device ID code unit 116 of the device circuit 112. The UPS unit 100 can be suitable for use in different type of device circuit 112. Further still, the UPS unit 100 can also simultaneously supply power to at least two device circuits 112.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. A universal power supply (UPS) system, comprising:
a device circuit, wherein the device circuit comprises
a device ID code unit, storing a device ID code of the device circuit, and
a power input interface, used to transmit a needed power to the device circuit;
a UPS unit, wherein the UPS unit comprises
a voltage supply unit,
a device ID detecting unit that can detect the device ID code stored in the device ID code unit of the device circuit, and
a voltage control unit, that controls the voltage unit to supply a power type of the needed power, according to the device ID code; and
a standard interface unit, coupled between the device circuit and the UPS unit, to supply the needed power to the device circuit and transmitting the device ID code.

2. The UPS system of claim 1, wherein the voltage supply unit comprises a rechargeable battery associated with a charger.

3. The UPS system of claim 1, wherein the voltage supply unit of the UPS unit comprises a power transforming apparatus, allowing it to transform a power from an external public power source into a battery-type power.

4. The UPS system of claim 1, wherein the standard interface unit comprises:
a standard connector, having a standardized size and comprising a plurality of plug holes, the plug holes being defined with functions according to a type of the device circuit; and
a multi-wire cable, coupled between the device circuit and the UPS unit, with respect to the plug holes.

5. The UPS system of claim 4, wherein the multi-wire cable, comprises a power line, a grounded line, a device ID signal line, and a safety signal line, wherein the power line is used to transmit the needed power, the device ID signal line is used to transmitted the device ID code, the safety signal line is used to transmit a safety signal.

6. A universal power supply (UPS), which can provide a needed power to a device circuit through an interface device, the UPS comprising:
a voltage supply unit;
a device ID detecting unit that can detect an ID code of the device circuit through the interface device; and
a voltage control unit that supplies the needed power to the device circuit through the interface device.

7. The UPS of claim 6, wherein the voltage supply unit comprises a re-chargeable battery associated with a charger.

8. The UPS of claim 6, wherein the voltage supply unit comprises a power transforming apparatus, allowing it to transform a power from a external public power source into a battery-type power.

9. The UPS of claim 6, comprising an input/output end which comprises a plurality of plug holes, wherein the plug holes at least include a power plug hole, a grounded plug hole, a device ID code signal plug hole, and a safety signal plug hole, wherein the power plug hole can provide the needed power, the device ID code signal plug hole can be used to transmit the ID code, and the safety signal plug hole can be used to transmit a safety signal.

10. A universal power supply (UPS) system, comprising:
a device circuit;
a UPS unit; and
a standard interface unit, coupled between the device circuit and the UPS unit, thereby to supply a needed power to the device circuit.

11. A method for supplying power to a device circuit, comprising:
pre-setting a device ID code to the device circuit;
detecting the device ID code, to recognize a power type needed by the device circuit;
providing a power source apparatus; and
controlling the power source apparatus, according to the power type, to supply a power to the device circuit.

12. The method of claim 11, further comprising detecting a status for supplying power to the device circuit, to determine whether the status is under a normal condition.
